(19) United States
(12) Patent Application Publication
(10) Pub. No.: US 2019/0204808 A1
(43) Pub. Date: Jul. 4, 2019

(54) RISING AND LOWERING METHOD AND APPARATUS AND COMPUTER READABLE STORAGE MEDIUM

(71) Applicant: SHENZHEN CHINA STAR OPTOELECTRONICS SEMICONDUCTOR DISPLAY TECHNOLOGY CO., LTD., Shenzhen (CN)

(72) Inventor: Yanyue WEN, Shenzhen (CN)

(21) Appl. No.: 15/961,301

(22) Filed: Apr. 24, 2018

Related U.S. Application Data
(63) Continuation of application No. PCT/CN2018/072889, filed on Jan. 16, 2018.

(30) Foreign Application Priority Data
Dec. 29, 2017 (CN) 201711498522.9

(51) Int. Cl. G05B 19/4099; G05B 19/402

(52) U.S. Cl. CPC G05B 19/4099; G05B 2219/45224; G05B 2219/45212; G05B 19/402

(57) ABSTRACT

Provided is a rising and lowering method and apparatus and a computer readable storage medium. The rising and lowering method is used to adjust the distance between a panel and an electrode that are spaced apart from and parallel with each other. The method includes steps of: detecting a position of a geometric center of a panel and manipulating geometric center to move along a first direction by a first predetermined distance, wherein the first direction is perpendicular to a direction of panel; and setting up a first area and a second area which are symmetrical with respect to geometric center on panel, and manipulating first area and second area to move along a first direction by a second predetermined distance. The first predetermined distance is not equal to second predetermined distance. The invention can suppress the occurrence of warp on panel and ensure the panel to endure uniform force.

### RELATED APPLICATIONS

This application is a continuation application of PCT Patent Application No. PCT/CN2018/072889, filed Jan. 16, 2018, which claims the priority benefit of Chinese Patent Application No. 201711498522.9, filed Dec. 29, 2017, which is herein incorporated by reference in its entirety.

### FIELD OF THE DISCLOSURE

The invention relates to the field of control technology, and more particularly to a rising and lowering method and apparatus, and a computer readable storage medium.

### BACKGROUND

The etching technique is principally categorized into dry etching and wet etching. The dry etching technique mainly uses a reactant gas and plasma to perform the etching process. The wet etching technique mainly uses a chemical reagent to react with the substance which is to be etched so as to perform the etching process. When it is desired to process the panel with the dry etching process, one of the procedures in the dry etching process is to lay the panel on the surface of electrodes. However, as the size of the panel is quite large, the panel would be warped when it is laid down on the surface of electrodes. This would cause the panel to endure non-uniform force and would further crack the panel.

### SUMMARY

The invention is aimed to provide a rising and lowering method for adjusting the distance between the panel and the electrode. The panel and the electrode are spaced apart from and parallel with each other. The rising and lowering method includes the steps of:

detecting the position of the geometric center of the panel and manipulating the geometric center to move along a first direction by a first predetermined distance, in which the first direction is perpendicular to the direction of the panel; setting up a first area and a second area on the panel, both of which are symmetrical with respect to the geometric center; manipulating the first area and the second area to move along the first direction by a second predetermined distance, in order to meet the requirement of: the first predetermined distance is not equal to the second predetermined distance. Thus, we can manipulate different parts or areas of the panel to approach or depart from the electrode. That is, by manipulating the geometric center of the panel to move a first predetermined distance, and manipulating the first area and the second area of the panel to move a second predetermined distance which is not equal to the first predetermined distance, the form of the panel can be adapted depending on the actual working state. This would reduce the possibility of causing warp on the panel and ensure that the panel endures uniform force.

The invention further provides a rising and lowering apparatus, which includes a storage device and a processor. The storage device stores a rising and lowering algorithm, and the processor reads the rising and lowering algorithm to carry out the aforementioned rising and lowering method.

The invention further provides a computer readable storage medium for storing a rising and lowering algorithm, in which the execution of the rising and lowering algorithm carries out the aforementioned rising and lowering method.

### BRIEF DESCRIPTION OF THE DRAWINGS

To illustrate the structural features and effect of the invention in a clear manner, the invention will be described in detail with reference to the accompanying drawings and an exemplary embodiment. Apparently, the accompanying drawings stated below are merely affiliated to some embodiments of the invention. An artisan having ordinary skill in the art can devise other drawings based on the accompanying drawings without exerting non-inventive laboring. In the figures:

FIG. 1 is a flow chart illustrating the rising and lowering method according to an embodiment of the invention;

FIG. 2 is a flow chart illustrating the sub-steps of the step S100 of the rising and lowering method according to an embodiment of the invention;

FIG. 3 is a schematic diagram showing the structure for illustrating the sub-step S110 of the rising and lowering method according to an embodiment of the invention;

FIG. 4 is a schematic diagram showing the structure for illustrating the sub-step S120 of the rising and lowering method according to an embodiment of the invention;

FIG. 5 is a flow chart illustrating a sub-step of the step S100 of the rising and lowering method according to an embodiment of the invention;

FIG. 6 is a schematic diagram showing the structure for illustrating the sub-step S130 of the rising and lowering method according to an embodiment of the invention;

FIG. 7 is a partial zoom-in diagram of the zone Z shown in FIG. 6;

FIG. 8 is a cross-sectional view showing the cross section of the panel according to an embodiment of the invention;

FIG. 9 is a schematic diagram showing the supporting members disposed between the panel and the electrode according to an embodiment of the invention;

FIG. 10 is a schematic diagram showing the allocation of the first supporting member and the second supporting member according to a preferred embodiment of the invention;

FIG. 11 is a schematic diagram showing the panel approaching the electrode according to an embodiment of the invention;

FIG. 12 is a schematic diagram showing the panel departing from the electrode according to another embodiment of the invention;

FIG. 13 is a flow chart illustrating an additional step of the rising and lowering method according to an embodiment of the invention;

FIG. 14 is a schematic diagram showing the structure for illustrating the additional step S300 of the rising and lowering method according to an embodiment of the invention;

FIG. 15 is a schematic diagram showing the panel approaching the electrode according to a preferred embodiment of the invention;

FIG. 16 is a schematic diagram showing the panel departing from the electrode according to a preferred embodiment of the invention;

FIG. 17 is a schematic diagram showing the allocation of the supporting members according to a preferred embodiment of the invention; and

FIG. 18 is a systematic diagram showing the system of the rising and lowering apparatus according to a preferred embodiment of the invention.

### DETAILED DESCRIPTION OF PREFERRED EMBODIMENTS

Next, the technological scheme embodying the embodiment of the invention will be described with reference to the accompanying drawings in a clear and complete manner. Apparently, the embodiment described herein does not exhaustively encompass all possible embodiments of the invention. Based on the embodiment of the invention disclosed herein, all other embodiments devised without inventive laboring by an artisan having ordinary skill in the art should be within the scope of the invention.

The phrase “ranged from . . . to” used throughout the specification indicates a range between a minimum value and a maximum value respectively specified by the numeral enumerated in the phrase. In the figures, elements with the same or similar structure is labeled with the same reference numeral.

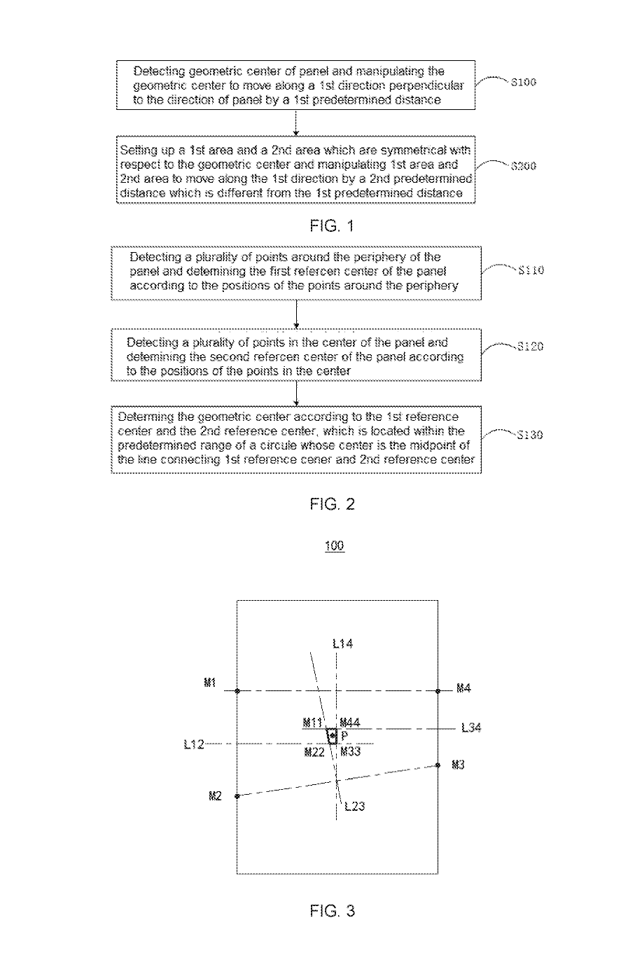

Please refer to FIG. 1, which shows the flow chart illustrating the rising and lowering method according to an embodiment of the invention. The rising and lowering method is used to adjust the distance between the panel 100 and the electrode 200. The panel 100 and the electrode 200 are spaced apart from and parallel with each other. In one embodiment, the rising and lowering method includes, but not limited to, steps S100 and S200. The details of these steps are discussed below.

S100: detecting the position of the geometric center 110 of the panel 100 and manipulating the geometric center 110 to move along a first direction by a first predetermined distance d1, in which the first direction is perpendicular to the direction of the panel 100.

The panel 100 includes at least one symmetrical axis 100a. The symmetrical axis 100a passes through the geometric center 110 of the panel 100.

Optionally, the shape of the panel 100 may be rectangular, round, oval, or other symmetrical shapes. In case that the shape of the panel 100 is rectangular, the geometric center 110 is the intersection of the diagonal lines of the panel 100. In this case, the panel 100 includes at least two symmetrical axes 100a, all of which pass through the geometric center 110 of the panel 100. In a particular case, for example, in case that the shape of the panel 100 is square, the geometric center 110 is the intersection of the diagonal lines of the panel 100. In this case, the panel 100 includes four symmetrical axes 100a, all of which pass through the geometric center 110 of the panel 100. In case that the shape of the panel 100 is round, the geometric center 110 is the center of circle of the panel 100. In this case, the panel 100 includes an infinite number of symmetrical axes 100a, all of which pass through the geometric center 110. In case that the shape of the panel 100 is oval, the panel 100 includes two symmetrical axes 100a, both of which pass through the geometric center 110.

Please refer to FIG. 2, which illustrates the sub-steps of the step S100 of the rising and lowering method according to an embodiment of the invention. Concretely speaking, the step of “detecting the position of the geometric center of the panel 100” includes, but not limited to, sub-steps S110, S120, and S130. The details of these sub-steps are discussed below.

S110: detecting the positions of a plurality of points around the periphery of the panel 100, and determining a first reference center of the panel 100 according to the positions of points around the periphery of the panel 100.

Please refer to FIG. 3, which shows the structure for illustrating the sub-step S110 of the rising and lowering method according to an embodiment of the invention. Concretely speaking, we arbitrarily pick a plurality of points around the periphery of the panel 100. For example, we arbitrarily pick four points around the periphery of the panel 100, each of which is located at a different side. These four points are picked scatteredly to ensure preciseness of the method. These four points are respectively labeled as M1, M2, M3, and M4. In this way, these points M1, M2, M3, and M4 constitute a quadrangle M1M2M3M4. Next, we draw a perpendicular bisector L12 of the line M1 M2, draw a perpendicular bisector L23 of the line M2M3, draw a perpendicular bisector L34 of the line M3M4, and draw a perpendicular bisector L14 of the line M1M4. These lines L12, L23, L34, and L14 constitute a new quadrangle M11M22M33M44. Then we arbitrarily pick a point P inside the quadrangle M11M22M33M44, and take the point P as the first reference center for the panel 100.

S120: detecting the positions of a plurality of points in the center of panel 100, and determining a second reference center of the panel 100 according to the positions of the points in the center of panel 100.

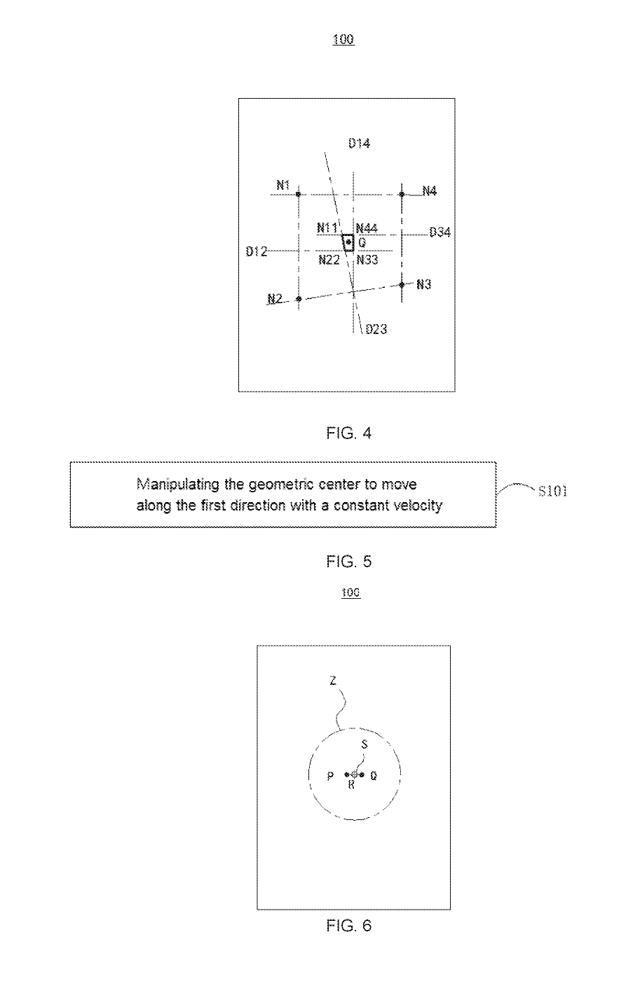

Please refer to FIG. 4, which shows the structure for illustrating the sub-step 120 of the rising and lowering method according to an embodiment of the invention. Concretely speaking, we arbitrarily pick a plurality of points in the center of the panel 100. For example, we arbitrarily pick four points in the center of the panel 100. These four points are picked scatteredly to ensure preciseness of the method. These four points are respectively labeled as N1, N2, N3, and N4. In this way, these points N1, N2, N3, and N4 constitute a quadrangle N1N2N3N4. Next, we draw a perpendicular bisector D12 of the line N1N2, draw a perpendicular bisector D23 of the line N2N3, draw a perpendicular bisector D34 of the line N3N4, and draw a perpendicular bisector D14 of the line N1N4. These lines D12, D23, D34, and D14 constitute a new quadrangle N11N22N33N44. Then we arbitrarily pick a point Q inside the quadrangle N11N22N33N44, and take the point Q as the second reference center for the panel 100.

Please refer to FIG. 5, which shows a flow chart illustrating a sub-step of the step S100 of the rising and lowering method according to an embodiment of the invention. Concretely speaking, the step of “manipulating the geometric center to move along a first direction by a first predetermined distance” includes, but not limited to, a sub-step S101. The sub-step S101 is descried in detail as follows:

S101: manipulating the geometric center 110 to move along the first direction with a constant velocity.

Preferably, during the procedure of manipulating the geometric center 110 to move along the first direction, the velocity of the movement is kept constant. That is, the movement of the panel 100 along the first direction is an uniform motion. As the size of the panel is usually large, the uniform motion can ensure that the acceleration of the panel 100 is 0 during the movement of the panel 100. This would protect the panel 100 from being affected by any external force and allow the panel to maintain force equilibrium. Thus, the panel 100 would be safe from non-uniform stress which would damage the panel 100.

Next, the sub-step S130 is performed, in which:

S130: determining the geometric center 110 according to the first reference center P and the second reference center Q, in which the geometric center 110 is located within the predetermined range of a circle whose center is the midpoint R of the line connecting the first reference center P and the second reference center Q.

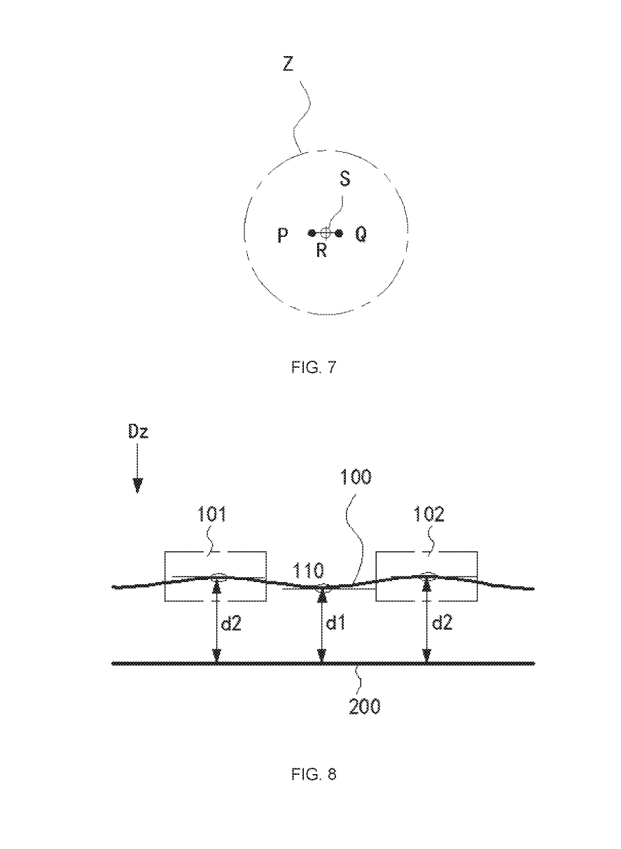

Please refer to FIG. 6 and FIG. 7, in which FIG. 6 shows the structure for illustrating the sub-step S130 of the rising and lowering method according to an embodiment of the invention, and FIG. 7 shows a partial zoom-in diagram of the zone Z shown in FIG. 6.

Concretely speaking, a line PQ is obtained by connecting the first reference center P and the second reference center Q. The midpoint of the line PQ is labeled as R. Taking R as the center of circle, we draw a circle with its radius being a relatively small value, and label the circle as S. The geometric center 110 is located within the predetermined range of circle S whose center is the midpoint R of the line connecting the first reference center P and the second reference center Q. This can more accurately determine the geometric center of the panel, because the points around the periphery of the panel and the points in the center of the panel are both picked. Moreover, because these points are scattered around as far as possible, the influence caused by occasional factor can be eliminated. Here, the occasional factor means the inaccurate result of picking resulted from picking points located within a small range on the panel. Furthermore, this embodiment adopts the centerline algorithm. By using a concrete algorithm to calculate the geometrical center, the accuracy of calculation will be enhanced, and the geometric center determined thereby will surely be close to the actual geometric center.

Next, the step S200 is performed, in which:

S200: setting up a first area 101 and a second area 102 on the panel 100, both of which are symmetrical with respect to the geometric center, and manipulating the first area 101 and the second area 102 to move along the first direction by a second predetermined distance d2, in which the first predetermined distance d1 is not equal to the second predetermined distance d2.

Please refer to FIG. 8, which shows the cross section of the panel according to an embodiment of the invention. In order to more clearly demonstrate the invention, the cross section of the panel 100 is taken along a first direction Dz for instance, in which the first direction Dz is perpendicular to the direction of the panel 100.

Concretely speaking, when the position of the geometric center 110 of the panel 100 is detected, the geometric center 110 is manipulated to move along the first direction Dz by a first predetermined distance d1. Afterwards, a first area 101 and a second area 102 are set up on the panel 100, both of which are symmetrical with respect to the geometrical center 110, and the first area 101 and the second area 102 are manipulated to move along the first direction by a second predetermined distance d2, in which the first predetermined distance d1 is not equal to the second predetermined distance d2. That is, the magnitude of the movement of the geometric center 110 of the panel 100 is not coherent with the magnitude of the movement of the first area 101 and the second area 102. In this way, we can manipulate different parts or areas of the panel 100 to approach or depart from the electrode 200. That is, by making the first predetermined distance d1 for the movement of the geometric center 110 of the panel 100 unequal to the second predetermined distance d2 for the movement of the first area 101 and the second area 102, the form of the panel 100 can be adapted depending on the actual working state. Thus, the possibility of causing warp on the panel 100 may be reduced, thereby ensuring the panel 100 to endure uniform force.

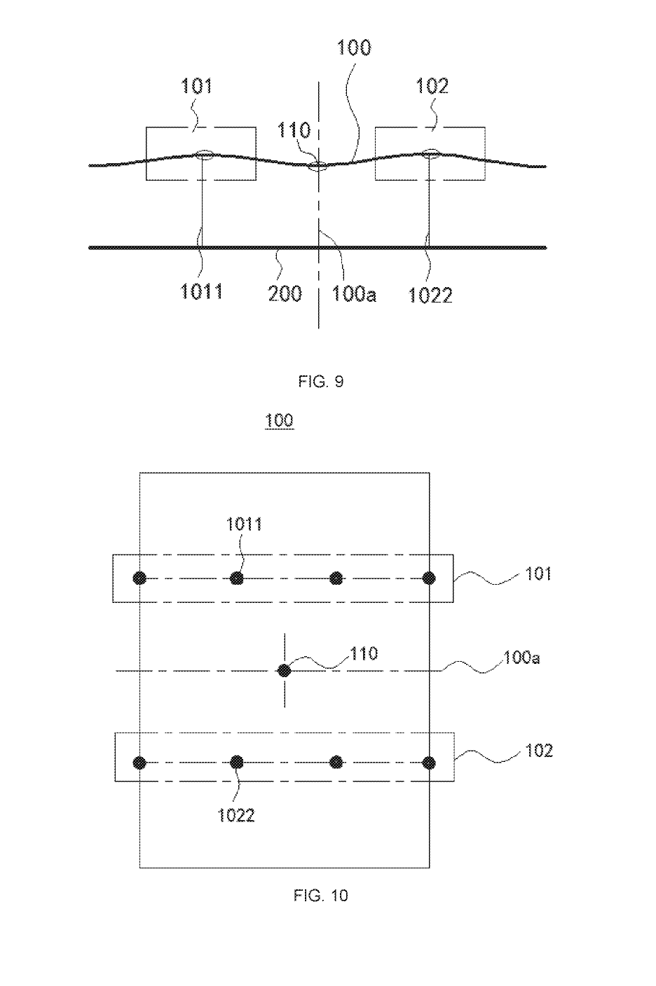

Please refer to FIG. 9, which shows the supporting members disposed between the panel and the electrode according to an embodiment of the invention.

In FIG. 9, a plurality of first supporting members 1011 are disposed in the first area 101, and a plurality of second supporting members 1022 are disposed in the second area 102. The first supporting members 1011 and the second supporting members 1022 are symmetrical with respect to a symmetrical axis 100a. The first supporting members 1011 and the second supporting members 1022 are configured to support the panel 100 and the electrode 200.

Concretely speaking, the intervals between any two adjacent first supporting members 1011 are equal to each other, and the intervals between any two adjacent second supporting members 1022 are equal to each other.

Please refer to FIG. 10, which shows the allocation of the first supporting member and the second supporting member according to a preferred embodiment of the invention.

The first area 101 and the second area 102 are symmetrical with respect to the symmetrical axis 100a. The intervals between two adjacent first supporting members 1011 in the first area 101 are equal to each other. That is, the first supporting members 1011 are uniformly distributed in the first area 101. Preferably, the first supporting members 1011 are linearly distributed in the first area 101. This can ensure that the force endured by the panel 100 is linearly variable, which would facilitate the relief of stress concentration. Moreover, the first supporting members 1011 in the first area 101 and the second supporting members 1022 in the second area 102 are also distributed symmetrically with respect to the symmetrical axis 100a. The first supporting members 1011 in the first area 101 and the second supporting members 1022 in the second area 102 are able to keep moving in synchronization with each other during the movement of the panel 100. That is, the first supporting members 1011 in the first area 101 and the second supporting members 1022 in the second area 102 both have the same moving distance. This can ensure that the stress endured by the panel 100 is distributed symmetrically, thereby facilitating the release of the stress and relieving the problem of stress concentration on the panel 100. This would enable the panel 100 to endure uniform force and protect the panel 100 from being cracked, thereby prolonging the lifespan of the panel 100.

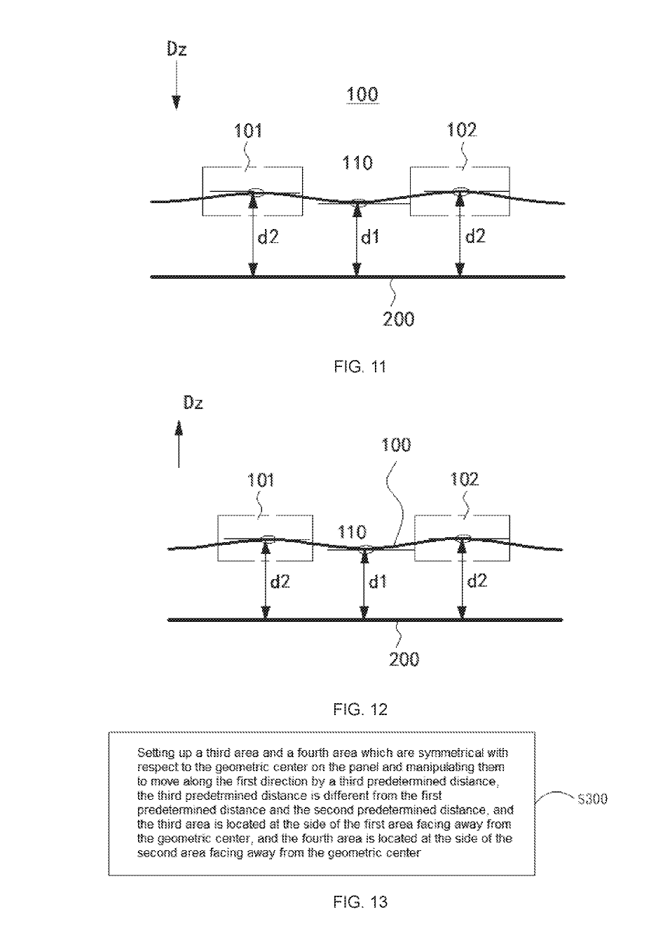

Please refer to FIG. 11, which shows the panel approaching the electrode according to an embodiment of the invention. Concretely speaking, if the first direction is the direction of which the panel 100 approaches the electrode 200, the first predetermined distance d1 is longer than the second predetermined distance d2, In this case, the geometric center 110 is first manipulated to move along the first direction Dz by the first predetermined distance d1, and then the first area 101 and the second area 102 are manipulated to move along the first direction Dz by the second predetermined distance d2.

In this embodiment, when the panel 100 is approaching the electrode 200, the geometric center 110 is first manipulated to approach the electrode 200 along the first direction Dz, and then the first area 101 and the second area 102 are manipulated to approach the electrode 200 along the first direction Dz, Moreover, the second predetermined distance d2 by which the first area 101 and the second area 102 are manipulated to move is shorter than the first predetermined distance d1 by which the panel 100 is manipulated to move. This can ensure that the contact area of the panel 100 with the surface of the electrode 200 will be aggrandized stepwise so as to allow the stress to be radically diverged toward the periphery of the panel 100. This is helpful in releasing the stress and addressing the problem of stress concentration on the panel 100. Therefore, this can ensure that the panel 100 endures uniform force and be protected from being cracked, thereby prolonging the lifespan of the panel 100.

In an alternative embodiment, when the panel 100 is approaching the electrode 200, the geometric center 110 of the panel 100 is manipulated to approach the electrode 200 along the first direction Dz. In the meantime, the first area 101 and the second area 102 are synchronously manipulated to approach the electrode 200 along the first direction Dz. However, the velocity of the geometric center 110 of the panel 100 approaching the electrode 200 is larger than the velocity of the first area 101 and the second area 102 approaching the electrode 200 along the first direction Dz. That is, when the panel 100 reaches the surface of the electrode 200, it is ensured that the geometric center 110 of the panel 100 reaches the surface of the electrode 200 first, and the second predetermined distanced d2 by which the first area 101 and the second area 102 are manipulated to move is shorter than the first predetermined distanced d1 by which the panel 100 is manipulated to move. This can ensure that the contact area of the panel 100 with the electrode 200 is aggrandized stepwise, so as to radically diverge the stress toward the periphery of the panel 100 and facilitate the release of the stress. Thus, the problem of stress concentration on the panel 100 is relieved to ensure that the panel 100 endures uniform force and be protected from being cracked. In this manner, the lifespan of the panel 100 is prolonged. If the panel 100 is warped on the surface of the electrode 200, the electric potential of the panel 100 will become locally unstable and thus induce potential difference, which would in turn result in arc discharge. That is, the surface of the panel 100 will induce electrostatic discharge, which would interfere the normal functionality of the panel 100.

Please refer to FIG. 12, which shows the panel departing from the electrode according to another embodiment of the invention. Concretely speaking, if the first direction is the direction of which the panel 100 departs from the electrode 200, the first predetermined distance d1 is shorter than the second predetermined distance d2. The first area 101 and the second area 102 are first manipulated to move along the first direction by the second predetermined distance d2, and then the geometric center 110 is manipulated to move along the first direction by the first predetermined distance d1.

In one embodiment, when the panel 100 is departing from the electrode 200, the first area 101 and the second area 102 has to be manipulated to move along the first direction Dz to keep away from the electrode 200. Then the geometric center 110 of the panel 100 is manipulated to move along the first direction Dz to keep away from the electrode 200. Also, the second predetermined distance d2 by which the first area 101 and the second area 102 are manipulated to move is longer than the first predetermined distance d1 by which the panel 100 is manipulated to move. This can ensure that the contact area of the panel 100 with the electrode 200 is decreased stepwise when the panel 100 is departing from the electrode 200. Thus, the stress can be radically diverged toward the periphery of the panel 100. This can facilitate the release of stress and efficiently relieve the stress concentration problem of the panel 100. Moreover, this can ensure that the panel 100 endures uniform force and protects the panel 100 from being cracked, and thereby prolonging the lifespan of the panel 100.

In an alternative embodiment, when the panel 100 is departing from the electrode 200, the geometric center 110 of the panel 100 is manipulated to depart from the electrode 200 along the first direction Dz. In the meantime, the first area 101 and the second area 102 are synchronously manipulated to depart from the electrode 200 along the first direction Dz. However, the velocity of the geometric center 110 of the panel 100 departing from the electrode 200 is smaller than the velocity of the first area 101 and the second area 102 departing from the electrode 200 along the first direction Dz. That is, when the panel 100 is departing from the surface of the electrode 200, it is ensured that the geometric center 110 of the panel 100 leaves the surface of the electrode 200 later. That is, the second predetermined distance d2 by which the first area 102 and the second area 102 are manipulated to move is shorter than the first predetermined distance d1 by which the panel 100 is manipulated to move, thereby ensuring that the contact area of the panel 100 is decreased stepwise when the panel 100 is departing from the surface of the electrode 200. In this way, the stress is able to be radically diverged toward the periphery of the panel 100. This can facilitate the release of stress and efficiently relieve the stress concentration problem of the panel 100. Moreover, this can ensure that the panel 100 endures uniform force and protects the panel 100 from being cracked, and thereby prolonging the lifespan of the panel 100.

Please refer to FIG. 13, which illustrates an additional step of the rising and lowering method according to an embodiment of the invention. In an alternative embodiment, the rising and lowering method may include, but not limited to, step S300. The step S300 is described in detail as follows:

S300: setting up a third area 103 and a fourth area 104 on the panel, both of which are symmetrical with respect to the geometric center 110, and manipulating the third area 103 and the fourth area 104 to move along the first direction by a third predetermined distance, in which the third predetermined distance is not equal to the first predetermined distance or the second predetermined distance, and the third area 103 is located at the side of the first area 101 facing away from the geometric center 110, and the fourth area 104 is located at the side of the second area 102 facing away from the geometric center 110.

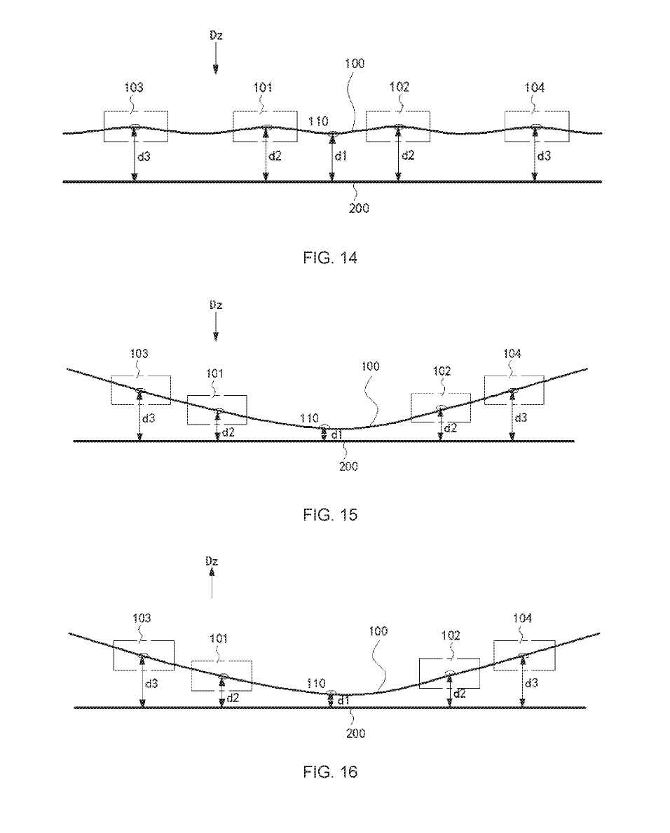

Please refer to FIG. 14, which shows the structure for illustrating the additional step S300 of the rising and lowering method according to an embodiment of the invention. For the sake of illustration, the cross section of the panel 100 is taken as an example.

Concretely speaking, when the first direction is the direction of which the panel 100 approaches the electrode 200, the first predetermined distance d1 is longer than the second predetermined distance d2, and the second predetermined distance d2 is longer than the third predetermined distance d3.

Please refer to FIG. 15, which shows the panel approaching the electrode according to a preferred embodiment of the invention. In one embodiment, when the panel 100 is approaching the electrode 200, the geometric center 110 of the panel 100 is manipulated to approach the electrode 200 along the first direction Dz, and then the first area 101 and the second area 102 are manipulated to approach the electrode 200 along the first direction Dz, and finally the third area 103 and the fourth area 104 are manipulated to approach the electrode 200 along the first direction Dz. The third predetermined distance d3 by which the third area 103 and the fourth area 104 are manipulated to move is shorter than the second predetermined distance d2 by which the first area 101 and the second area 102 are manipulated to move, and the second predetermined distance d2 by which the first area 101 and the second area 102 are manipulated to move is shorter than the first predetermined distance d1 by which the panel 100 is manipulated to move. This can ensure that the contact area of the panel 100 with the electrode 200 is aggrandized stepwise when the panel 100 is approaching the electrode 200, so as to radically diverge the stress toward the periphery of the panel 100 and facilitate the release of the stress. Thus, the problem of stress concentration on the panel 100 is relieved to ensure that the panel 100 endures uniform force and be protected from being cracked. In this manner, the lifespan of the panel 100 is prolonged.

In an alternative embodiment, when the panel 100 is approaching the electrode 200, the geometric center 110 of the panel 100 is manipulated to approach the electrode 200 along the first direction Dz. In the meantime, the first area 101 and the second area 102 are synchronously manipulated to approach the electrode 200 along the first direction Dz, and the third area 103 and the fourth area 104 are synchronously manipulated to approach the electrode 200 along the first direction Dz too. However, the velocity of the geometric center 110 of the panel approaching the electrode 200 is larger than the velocity of the first area 101 and the second area 102 approaching the electrode 200 along the first direction Dz, and the velocity of the first area 101 and the second area 102 approaching the electrode 200 is larger than the velocity of the third area 103 and the fourth area 104 approaching the electrode 200 along the first direction Dz. That is, when the panel 100 reaches the surface of the electrode 200, it is ensured that the geometric center 110 of the panel 100 reaches the surface of the electrode 200 first, and the third predetermined distance d3 by which the third area 103 and the fourth area 104 are manipulated to move is shorter than the second predetermined distance d2 by which the first area 101 and the second area 12 are manipulated to move, and the second predetermined distance d2 by which the first area 101 and the second area 12 are manipulated to move is shorter than the first predetermined distance d1 by which the panel 100 is manipulated to move. This can ensure that the contact area of the panel 100 with the electrode 200 is aggrandized stepwise when the panel 100 is approaching the electrode 200, so as to radically diverge the stress toward the periphery of the panel 100 and facilitate the release of the stress. Thus, the problem of stress concentration on the panel 100 is relieved to ensure that the panel 100 endures uniform force and be protected from being cracked. In this manner, the lifespan of the panel 100 is prolonged.

When the first direction Dz is the direction of the panel 100 departing from the electrode 200, the first predetermined distance d1 is shorter than the second predetermined distance d2, and the second predetermined distance d2 is shorter than the third predetermined distance d3.

Please refer to FIG. 16, which shows the panel departing from the electrode according to a preferred embodiment of the invention. In one embodiment, when the panel 100 is departing from the electrode 200, the third area 103 and the fourth area 104 are manipulated to depart from the electrode 200 along the first direction Dz, and then the first area 101 and the second area 102 are manipulated to depart from the electrode 200 along the first direction Dz, and finally the geometric center 110 of the panel 100 is manipulated to depart from the electrode 200 along the first direction Dz. The third predetermined distance d3 by which the third area 103 and the fourth area 104 are manipulated to move is longer than the second predetermined distance d2 by which the first area 101 and the second area 102 are manipulated to move, and the second predetermined distance d2 by which the first area 101 and the second area 102 are manipulated to move is longer than the first predetermined distance d1 by which the panel 100 is manipulated to move. This can ensure that the contact area of the panel 100 with the electrode 200 is decreased stepwise when the panel 100 is departing from the electrode 200, so as to radically diverge the stress toward the periphery of the panel 100 and facilitate the release of the stress. Thus, the problem of stress concentration on the panel 100 is relieved to ensure that the panel 100 endures uniform force and be protected from being cracked. In this manner, the lifespan of the panel 100 is prolonged.

In an alternative embodiment, when the panel 100 is departing from the electrode 200, the geometric center 110 of the panel 100 is manipulated to depart from the electrode 200 along the first direction Dz. In the meantime, the first area 101 and the second area 102 are synchronously manipulated to depart from the electrode 200 along the first direction Dz, and the third area 103 and the fourth area 104 are synchronously manipulated to depart from the electrode 200 along the first direction Dz too. However, the velocity of the geometric center 110 of the panel departing from the electrode 200 is smaller than the velocity of the first area 101 and the second area 102 departing from the electrode 200 along the first direction Dz, and the velocity of the first area 101 and the second area 102 departing from the electrode 200 is smaller than the velocity of the third area 103 and the fourth area 104 departing from the electrode 200 along the first direction Dz. That is, when the panel 100 departs from the surface of the electrode 200, it is ensured that the geometric center 110 of the panel 100 departs from the surface of the electrode 200 later, and the third predetermined distance d3 by which the third area 103 and the fourth area 104 are manipulated to move is longer than the second predetermined distance d2 by which the first area 101 and the second area 12 are manipulated to move, and the second predetermined distance d2 by which the first area 101 and the second area 12 are manipulated to move is longer than the first predetermined distance d1 by which the panel 100 is manipulated to move. This can ensure that the contact area of the panel 100 with the electrode 200 is decreased stepwise when the panel 100 is departing from the electrode 200, so as to radically diverge the stress toward the periphery of the panel 100 and facilitate the release of the stress. Thus, the problem of stress concentration on the panel 100 is relieved to ensure that the panel 100 endures uniform force and be protected from being cracked. In this manner, the lifespan of the panel 100 is prolonged.

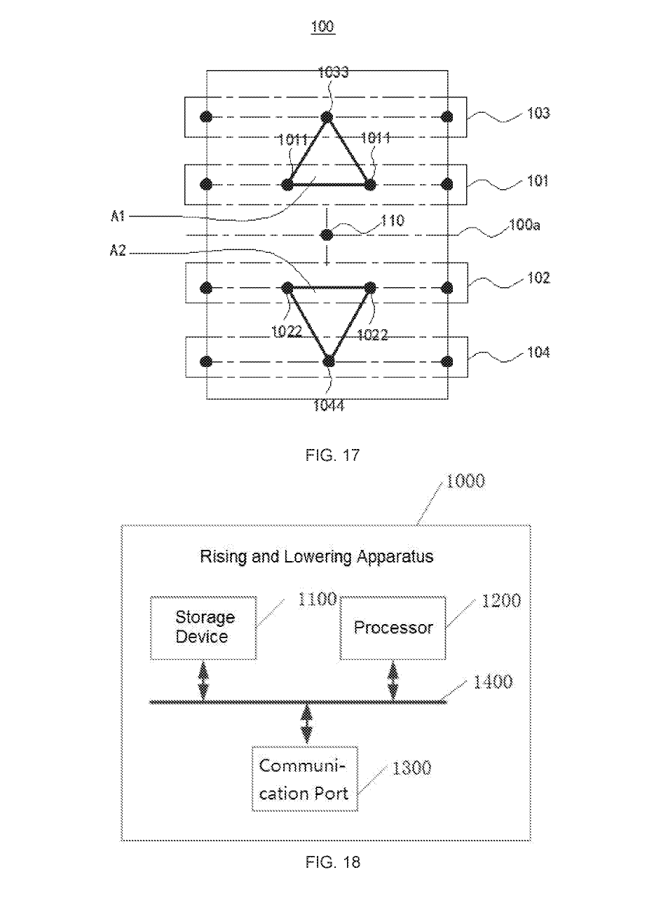

Please refer to FIG. 17, which shows the allocation of the supporting members according to a preferred embodiment of the invention. In an alternative embodiment, a plurality of third supporting members 1033 are disposed in the third area 103, and a plurality of fourth supporting members 1044 are disposed in the fourth area 104. The third supporting members 1033 and the fourth supporting members 1044 are used to support the panel 100 and the electrode 200. A third supporting member 1033 and two adjacent first supporting members 1011 constitute a first isosceles triangle A1, and a fourth supporting member 1044 and two adjacent second supporting members 1022 constitute a second isosceles triangle A2. A third supporting member 1033 and two adjacent first supporting members 1011 constitute a first isosceles triangle A1, and a fourth supporting member 1044 and two adjacent second supporting members 1022 constitute a second isosceles triangle A2. This configuration is based on the triangular stability, which is indicative of the features of stability, firmness, strongness, withstandingness of triangle. These features are found in triangular structures, such as Egyptian pyramids, steel rails, triangular framing, cranes, roofs, triangular steel trusses, and steel framed bridges. Hence, the supporting members structured with such allocation and configuration are helpful in enhancing the structural stability of the panel 100 and strengthening the endurance of the panel 100. This can ensure that the panel 100 is able to endure more stress and the lifespan of the panel 100 is prolonged accordingly.

Please refer to FIG. 18, which shows the system of the rising and lowering apparatus according to a preferred embodiment of the invention. The invention provides a rising and lowering apparatus 1000, which includes a storage device 1100 and a processor 1200. The storage device 1100 stores a rising and lower algorithm. The processor 1200 is able to read out the rising and lower algorithm from the storage device 1100 and execute the rising and lowering method as discussed above accordingly.

Please refer to FIG. 18 again. FIG. 18 outlines the rising and lowering apparatus 1000 involved in the foregoing embodiment. The rising and lowering apparatus 1000 includes a storage device 1100, a processor 1200, a communication port 1300, and a bus 1400. The processor 1200 is able to read out the rising and lowering algorithm from the storage device 1100 in order to execute the rising and lowering method discussed above. The storage device 1100, the processor 1200, the communication port 1300, and the bus 1400 are interconnected. The bus 1400 may be a PCI bus or an EISA bus. The bus 1400 may be an address bus, a data bus, or a control bus. For the sake of illustration, the bus 1400 is represented by a bold line. However, this does not mean that the bus 1400 is made up of a single bus or a particular type of bus.

An artisan skilled in the art may realize that the whole method or a part of the method discussed in the foregoing embodiment is able to be implemented by hardware capable of executing an algorithm containing computer executable instructions. The algorithm is stored in a computer readable storage medium. When the algorithm is executed, the procedure may includes the steps disclosed in the foregoing embodiment. The storage medium may be a hard disk, an optical disk, a read-only memory, or a random-access memory.

The invention provides a rising and lowering method for adjusting the distance between a panel and an electrode. The panel and the electrode are spaced apart from and parallel with each other. By detecting the position of the geometric center of the panel, the geometric center of the panel is manipulated to move along a first direction by a first predetermined distance. The first direction is perpendicular to the direction of the panel. A first area and a second area are set up on the panel and are symmetrical with respect to the geometric center. By manipulating the first area and the second area to move along the first direction by a second predetermined distance and making the first predetermined distance unequal to the second predetermined distance, different parts of areas of the panel can approach or depart from the electrode in a desired manner. That is, by allowing the first predetermined distance by which the geometric center of the panel moves to be unequal to the second predetermined distance by which the first area and the second area move, the form of the panel can be adapted depending on the actual working state. This would reduce the possibility of causing warp on the panel and ensure that the panel endures uniform force.

Furthermore, when the panel is approaching the electrode, the geometric center of the panel is driven to approach the electrode first, such that the contact area of the panel with the surface of the electrode is aggrandized stepwise. This can diverge the stress toward the periphery of the panel so as to release the stress and relieve the problem of stress concentration. Further, this can ensure that the panel endures uniform force and prolong the lifespan of the panel. When the panel is departing from the electrode, the geometric center of the panel is driven to leave the surface of the electrode later, such that the contact area of the panel with the surface of the electrode is decreased stepwise. This can diverge the stress toward the periphery of the panel so as to release the stress and relieve the problem of stress concentration. Further, this can ensure that the panel endures uniform force and be protected from being cracked, thereby prolonging the lifespan of the panel.

Further, the first area and the second area of the panel are symmetrical with respect to the symmetrical axis of the panel. The first area is provided with a plurality of first supporting members and the second area is provided with a plurality of second supporting members. The first supporting members and the second supporting members are used to support the panel and the electrode. The panel only have to endure part of the adsorption force around the supporting members. Because the panel is rising or lowering symmetrically, the stress can be released along the symmetrical direction, even though the panel is enduring excessive force. This can avoid the occurrence of stress concentration and give protection for the panel, and prolong the lifespan of the panel.

Further, the supporting members are disposed between the panel and the electrode and are arranged in an organized manner. That is, based on the theorem of the triangular stability, a third supporting member and two adjacent first supporting members constitute a first isosceles triangle, and a fourth supporting member and two adjacent second supporting members constitute a second isosceles triangle. Hence, such allocation and configuration of the supporting members can enhance the structural stability of the panel and enhance the endurance of the panel. This can ensure that the panel is able to endure a relatively large stress and prolong the lifespan of the panel.

The invention has been elaborated by way of the foregoing embodiment. The principle and embodiment of the invention are described through several concrete examples. The foregoing embodiment is given to help an artisan understand the methodology and core concepts of the invention. Also, an artisan having ordinary skill in the art may make alterations to the practical usage and applicability of the invention based on the concept of the invention. In conclusion, the specification should not be construed as a limitation to the invention.

What is claimed is:

1. A rising and lowering method for adjusting the distance between a panel and an electrode, wherein the panel and the electrode are spaced apart from and parallel with each other, the rising and lowering method comprising the steps of:
detecting a position of a geometric center of the panel and manipulating the geometric center to move along a first direction by a first predetermined distance, wherein the first direction is perpendicular to a direction of the panel; and
setting up a first area and a second area on the panel, both of which are symmetrical with respect to the geometric center, and manipulating the first area and the second area to move along the first direction by a second predetermined distance, wherein the first predetermined distance is not equal to the second predetermined distance.

2. The rising and lowering method according to claim 1, wherein:
when the first direction is the direction of which the panel approaches the electrode, the first predetermined distance is longer than the second predetermined distance, and wherein the geometric center is manipulated to move along the first direction by the first predetermined distance first, and then the first area and the second area are manipulated to move along the first direction by the second predetermined distance; and
when the first direction is the direction of which the panel departs from the electrode, the first predetermined distance is shorter than the second predetermined distance, and wherein the first area and the second area are manipulated to move along the first direction by the second predetermined distance first, and then the geometric center is manipulated to move along the first direction by the first predetermined distance.

3. The rising and lowering method according to claim 1, further comprising the steps of:
setting up a third area and a fourth area on the panel, both of which are symmetrical with respect to the geometric center, and manipulating the third area and the fourth area to move along a first direction by a third predetermined distance, wherein the third predetermined distance is not equal to first predetermined distance or the second predetermined distance, and wherein the third area is located at the side of the first area facing away from the geometric center, and the fourth area is located at the side of the second area facing away from the geometric center.

4. The rising and lowering method according to claim 3, wherein:
when the first direction is the direction of which the panel approaches the electrode, the first predetermined distance is longer than the second predetermined distance and the second predetermined distance is longer than the third predetermined distance; and
when the first direction is the direction of which the panel departs from the electrode, the first predetermined distance is shorter than the second predetermined distance and the second predetermined distance is shorter than the third predetermined distance.

5. The rising and lowering method according to claim 1, wherein the step of detecting a position of a geometric center of the panel includes the sub-steps of:
detecting a plurality of points around a periphery of the panel and determining a first reference center of the panel according to the positions of the plurality of points around the periphery of the panel;
detecting a plurality of points in the center of the panel and determining a second reference center of the panel according to the positions of the plurality of points in the center of the panel; and
determining the geometric center according to the first reference center and the second reference center, wherein the geometric center is located within a predetermined range of circle whose center is the midpoint of a line connecting the first reference center and the second reference center.

6. The rising and lowering method according to claim 3, wherein the panel includes at least one symmetrical axis passing through the geometric center of the panel.

7. The rising and lowering method according to claim 6, wherein the first area is provided with a plurality of first supporting members and the second area is provided with a plurality of second supporting members, and wherein the first supporting members and the second supporting members are symmetrical with respect to the symmetrical axis, and wherein the first supporting members and the second supporting members are used to support the panel and the electrode.

8. The rising and lowering method according to claim 7, wherein the third area is provided with a plurality of third supporting members and the fourth area is provided with a plurality of fourth supporting members, and wherein the third supporting members and the fourth supporting members are used to support the panel and the electrode, and wherein a third supporting member and two adjacent first supporting members constitute a first isosceles triangle, and a fourth supporting member and two adjacent second supporting members constitute a second isosceles triangle.

9. A rising and lowering apparatus, comprising:
a storage device; and
a processor;
wherein the storage device stores a rising and lowering algorithm, and the processor reads out the rising and lowering algorithm for executing a rising and lowering method;
wherein the rising and lowering method comprises the steps of:
detecting a position of a geometric center of a panel and manipulating the geometric center to move along a first direction by a first predetermined distance,
wherein the first direction is perpendicular to a direction of the panel; and
setting up a first area and a second area on the panel, both of which are symmetrical with respect to the geometric center, and manipulating the first area and the second area to move along the first direction by a second predetermined distance, wherein the first predetermined distance is not equal to the second predetermined distance.

10. The rising and lowering apparatus according to claim 9, wherein:
when the first direction is the direction of which the panel approaches an electrode, the first predetermined distance is longer than the second predetermined distance; and wherein the geometric center is manipulated to move along the first direction by the first predetermined distance first, and then the first area and the second area are manipulated to move along the first direction by the second predetermined distance; and
when the first direction is the direction of which the panel departs from the electrode, the first predetermined distance is shorter than the second predetermined distance, and wherein the first area and the second area are manipulated to move along the first direction by the second predetermined distance first, and then the geometric center is manipulated to move along the first direction by the first predetermined distance.

11. The rising and lowering apparatus according to claim 9, wherein the rising and lowering method further includes the steps of:
setting up a third area and a fourth area on the panel, both of which are symmetrical with respect to the geometric center; and manipulating the third area and the fourth area to move along a first direction by a third predetermined distance, wherein the third predetermined distance is not equal to first predetermined distance or the second predetermined distance; and wherein the third area is located at the side of the first area facing away from the geometric center, and the fourth area is located at the side of the second area facing away from the geometric center.

12. The rising and lowering apparatus according to claim 11, wherein:
when the first direction is the direction of which the panel approaches the electrode, the first predetermined distance is longer than the second predetermined distance and the second predetermined distance is longer than the third predetermined distance; and
when the first direction is the direction of which the panel departs from the electrode, the first predetermined distance is shorter than the second predetermined distance and the second predetermined distance is shorter than the third predetermined distance.

13. The rising and lowering apparatus according to claim 9, wherein the step of detecting a position of a geometric center of a panel includes the sub-steps of:
detecting a plurality of points around a periphery of the panel and determining a first reference center of the panel according to the positions of the plurality of points around the periphery of the panel;
detecting a plurality of points in the center of the panel and determining a second reference center of the panel according to the positions of the plurality of points in the center of the panel; and
determining the geometric center according to the first reference center and the second reference center, wherein the geometric center is located within a predetermined range of circle whose center is the midpoint of a line connecting the first reference center and the second reference center.

14. The rising and lowering apparatus according to claim 11, wherein the panel includes at least one symmetrical axis passing through the geometric center of the panel.

15. The rising and lowering apparatus according to claim 14, wherein the first area is provided with a plurality of first supporting members and the second area is provided with a plurality of second supporting members, and wherein the first supporting members and the second supporting members are symmetrical with respect to the symmetrical axis, and wherein the first supporting members and the second supporting members are used to support the panel and the electrode.

16. The rising and lowering apparatus according to claim 15, wherein the third area is provided with a plurality of third supporting members and the fourth area is provided with a plurality of fourth supporting members, and wherein the third supporting members and the fourth supporting members are used to support the panel and the electrode, and wherein a third supporting member and two adjacent first supporting members constitute a first isosceles triangle, and a fourth supporting member and two adjacent second supporting members constitute a second isosceles triangle.

17. A computer readable storage medium storing a rising and lowering algorithm for executing a rising and lowering method, wherein the rising and lowering method comprises the steps of:
detecting a position of a geometric center of a panel and manipulating the geometric center to move along a first direction by a first predetermined distance, wherein the first direction is perpendicular to a direction of the panel; and
setting up a first area and a second area on the panel, both of which are symmetrical with respect to the geometric center, and manipulating the first area and the second area to move along the first direction by a second predetermined distance, wherein the first predetermined distance is not equal to the second predetermined distance.

18. The computer readable storage medium according to claim 17, wherein:
when the first direction is the direction of which the panel approaches an electrode, the first predetermined distance is longer than the second predetermined distance, and wherein the geometric center is manipulated to move along the first direction by the first predetermined distance first, and then the first area and the second area are manipulated to move along the first direction by the second predetermined distance; and
when the first direction is the direction of which the panel departs from the electrode, the first predetermined distance is shorter than the second predetermined distance, and wherein the first area and the second area are manipulated to move along the first direction by the second predetermined distance first, and then the geometric center is manipulated to move along the first direction by the first predetermined distance.

19. The computer readable storage medium according to claim 17, wherein the rising and lowering method further includes the steps of:
setting up a third area and a fourth area on the panel, both of which are symmetrical with respect to the geometric center, and manipulating the third area and the fourth area to move along a first direction by a third predetermined distance, wherein the third predetermined distance is not equal to first predetermined distance or the second predetermined distance, and wherein the third area is located at the side of the first area facing away from the geometric center, and the fourth area is located at the side of the second area facing away from the geometric center.

20. The computer readable storage medium according to claim 19, wherein:
when the first direction is the direction of which the panel approaches the electrode, the first predetermined distance is longer than the second predetermined distance and the second predetermined distance is longer than the third predetermined distance; and
when the first direction is the direction of which the panel departs from the electrode, the first predetermined distance is shorter than the second predetermined distance and the second predetermined distance is shorter than the third predetermined distance.
